(19) United States
(12) Patent Application Publication
(10) Pub. No.: US 2018/0195775 A1
(43) Pub. Date: Jul. 12, 2018

(54) METHOD FOR FORMING A CALORIC REGENERATOR

(71) Applicants: Haier US Appliance Solutions, Inc., Wilmington, DE (US); UT-Battelle, LLC, Oak Ridge, TN (US)

(72) Inventors: Michael Goodman Schroeder, Louisville, KY (US); Michael Alexander Benedict, Louisville, KY (US); Ayyoub Mehdizadeh Momen, Knoxville, TN (US); Amelia McDow Elliott, Cleveland, TN (US); James O. Kiggans, JR., Oak Ridge, TN (US)

(21) Appl. No.: 15/403,239

(22) Filed: Jan. 11, 2017

(51) Int. Cl. F25B 21/00; B33Y 10/00; B33Y 80/00; B22F 3/105; B22F 7/00; B22F 5/10; B29C 67/00

(52) U.S. Cl. CPC F25B 21/00; B29K 2105/16; B33Y 80/00; B22F 3/1055; B22F 7/008; B22F 5/10; B29C 67/0081; F25B 2321/002; B22F 2201/10; B22F 2998/10; B22F 2302/45; B22F 2302/40; B22F 2301/35; B29K 2995/0008; B33Y 10/00

(57) ABSTRACT

A method for forming a caloric regenerator includes forming a first caloric material stage from a first plurality of caloric material layers by repeatedly laying down a first powder for each layer of the first plurality of caloric material layers, applying a first binder material onto the first powder for each layer of the plurality of first caloric material layers, and then fixing the layers of the first plurality of caloric material layers to one another. A second caloric material stage is formed in a similar manner. The first and second caloric material stages are stackable to form the caloric regenerator.

### STATEMENT REGARDING FEDERALLY SPONSORED RESEARCH AND DEVELOPMENT

This invention was made with government support under Contract No. DE-AC05-00OR22725 awarded by the U.S. Department of Energy and under a CRADA (CRADA No. NFE-13-04630) between General Electric Company and UT-Battelle, LLC, management and operating contractor for the Oak Ridge National Laboratory for the United States Department of Energy. The government has certain rights in the invention.

### FIELD OF THE INVENTION

The present subject matter relates generally to caloric regenerators and method for forming caloric regenerators.

### BACKGROUND OF THE INVENTION

Conventional refrigeration technology typically utilizes a heat pump that relies on compression and expansion of a fluid refrigerant to receive and reject heat in a cyclic manner so as to effect a desired temperature change or i.e. transfer heat energy from one location to another. This cycle can be used to provide e.g., for the receiving of heat from a refrigeration compartment and the rejecting of such heat to the environment or a location that is external to the compartment. Other applications include air conditioning of residential or commercial structures. A variety of different fluid refrigerants have been developed that can be used with the heat pump in such systems.

While improvements have been made to such heat pump systems that rely on the compression of fluid refrigerant, at best such can still only operate at about forty-five percent or less of the maximum theoretical Carnot cycle efficiency. Also, some fluid refrigerants have been discontinued due to environmental concerns. The range of ambient temperatures over which certain refrigerant-based systems can operate may be impractical for certain locations. Other challenges with heat pumps that use a fluid refrigerant exist as well.

Magneto-caloric materials (MCMs), i.e. materials that exhibit the magneto-caloric effect, provide a potential alternative to fluid refrigerants for heat pump applications. In general, the magnetic moments of an MCM will become more ordered under an increasing, externally applied magnetic field and cause the MCM to generate heat. Conversely, decreasing the externally applied magnetic field will allow the magnetic moments of the MCM to become more disordered and allow the MCM to absorb heat. Some MCMs exhibit the opposite behavior, i.e. generating heat when the magnetic field is removed (which are sometimes referred to as para-magneto caloric material but both types are referred to collectively herein as magneto-caloric material or MCM). The theoretical percent of Carnot cycle efficiency achievable for a refrigeration cycle based on an MCM can be significantly higher than for a comparable refrigeration cycle based on a fluid refrigerant. As such, a heat pump system that can effectively use an MCM would be useful.

Challenges exist to the practical and cost competitive use of an MCM, however. In addition to the development of suitable MCMs, equipment that can attractively utilize an MCM is still needed. For example, an MCM that transfers heat to a fluid with minimal energy usage would be useful. In particular, an MCM with that provides high heat transfer to the fluid and low pressure drop through the MCM would be useful.

### BRIEF DESCRIPTION OF THE INVENTION

The present subject matter provides a method for forming a caloric regenerator. The method includes forming a first caloric material stage from a first plurality of caloric material layers by repeatedly laying down a first powder for each layer of the first plurality of caloric material layers, applying a first binder material onto the first powder for each layer of the plurality of first caloric material layers, and then fixing the layers of the first plurality of caloric material layers to one another. A second caloric material stage is formed in a similar manner. The first and second caloric material stages are stackable to form the caloric regenerator. Additional aspects and advantages of the invention will be set forth in part in the following description, or may be apparent from the description, or may be learned through practice of the invention.

In a first exemplary embodiment, a method for forming a caloric regenerator is provided. The method includes forming a first caloric material stage from a first plurality of caloric material layers by repeatedly laying down a first powder for each layer of the first plurality of caloric material layers, applying a first binder material onto the first powder for each layer of the plurality of first caloric material layers, and then fixing the layers of the first plurality of caloric material layers to one another. The first binder material is applied such that the first caloric material stage has a tetrahedral topology, a pyramidal topology, a 3D Kagomé topology, a diamond weave topology, a square weave topology, or a honeycomb topology. The method also includes forming a second caloric material stage from a second plurality of caloric material layers by repeatedly laying down a second powder for each layer of the second plurality of caloric material layers, applying a second binder material onto the second powder for each layer of the plurality of second caloric material layers, and then fixing the layers of the second plurality of caloric material layers to one another, the second powder being different than the second powder. The first and second caloric material stages are stackable to form the caloric regenerator.

In a second exemplary embodiment, a method for forming a caloric regenerator is provided. The method includes step for forming a first caloric material stage from a first plurality of caloric material layers such that the first caloric material stage has a tetrahedral topology, a pyramidal topology, a 3D Kagomé topology, a diamond weave topology, a square weave topology, or a honeycomb topology. The method also includes step for forming a second caloric material stage from a second plurality of caloric material layers such that the second caloric material stage has a tetrahedral topology, a pyramidal topology, a 3D Kagomé topology, a diamond weave topology, a square weave topology, or a honeycomb topology. The first and second caloric material stages are stackable to form the caloric regenerator.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a refrigerator appliance in accordance with an exemplary embodiment of the present disclosure.

FIG. 2 is a schematic illustration of certain components of a heat pump system positioned in the exemplary refrigerator appliance of FIG. 1.

FIG. 3 is a schematic illustration of certain components of the heat pump system of FIG. 2, with a first stage of MCM within a magnetic field and a second stage of MCM out of a magnetic field, in accordance with an exemplary embodiment of the present disclosure.

FIG. 4 is a schematic illustration of certain components of the exemplary heat pump system of FIG. 2, with the first stage of MCM out of the magnetic field and the second stage of MCM within the magnetic field.

FIG. 5 is a front view of an exemplary caloric heat pump of the heat pump system of FIG. 2, with first stages of MCM within magnetic fields and second stages of MCM out of magnetic fields.

FIG. 6 is a front view of the exemplary caloric heat pump of the heat pump system of FIG. 2, with first stages of MCM out of magnetic fields and second stages of MCM within magnetic fields.

FIG. 7 is a top view of a regenerator housing and MCM stages of the exemplary caloric heat pump of FIG. 5.

FIG. 8 is a top view of certain components of the exemplary caloric heat pump of FIG. 5.

FIG. 9 is a chart illustrating movement of a regenerator housing and associated MCM stages in accordance with an exemplary embodiment of the present disclosure.

FIG. 10 is a chart illustrating operation of pumps to actively flow working fluid in accordance with an exemplary embodiment of the present disclosure.

FIG. 11 is a schematic diagram illustrating various positions and movements there-between of MCM stages in accordance with an exemplary embodiment of the present disclosure.

FIG. 12 provides a perspective view of a stack of caloric material stages according to an exemplary embodiment of the present subject matter.

FIG. 13 illustrates various caloric material stage topologies as may be formed with the exemplary method of FIG. 14.

FIG. 14 illustrates a method for forming a caloric material stage according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present subject matter may be utilized in a caloric heat pump system for heating or cooling an appliance, such as a refrigerator appliance. While described in greater detail below in the context of a magneto-caloric heat pump system, one of skill in the art using the teachings herein will recognize that other suitable caloric materials may be used in a similar manner to heat or cool an appliance, i.e., apply a field, move heat, remove the field, move heat. For example, electro-caloric material heats up and cools down within increasing and decreasing electric fields. As another example, elasto-caloric material heats up and cools down when exposed to increasing and decreasing mechanical strain. As yet another example, baro-caloric material heats up and cools down when exposed to increasing and decreasing pressure. Such materials and other similar caloric materials may be used in place of or in addition to the magneto-caloric material described below to heat or cool liquid/water within an appliance. Thus, caloric material is used broadly herein to encompass materials that undergo heating or cooling when exposed to a changing field from a field generator, where the field generator may be a magnet, an electric field generator, an actuator for applying mechanical stress or pressure, etc.

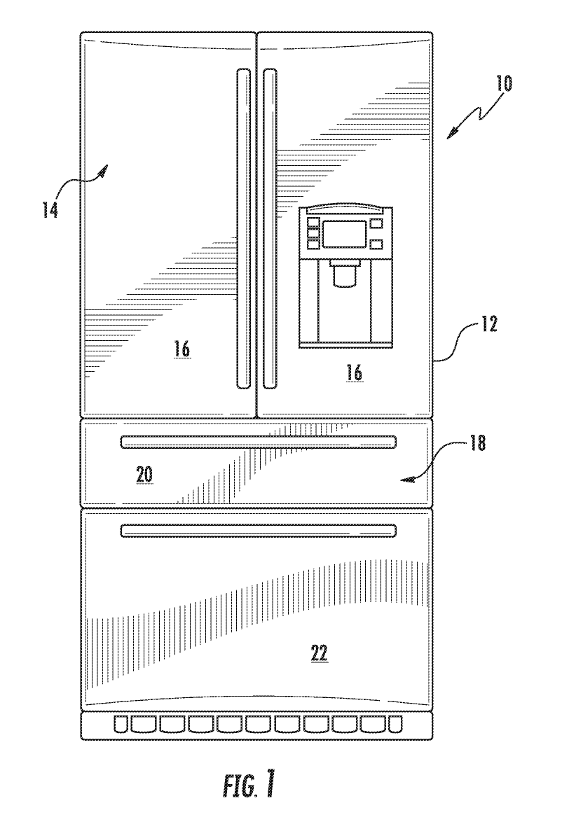

Referring now to FIG. 1, an exemplary embodiment of a refrigerator appliance 10 is depicted as an upright refrigerator having a cabinet or casing 12 that defines a number of internal storage compartments or chilled chambers. In particular, refrigerator appliance 10 includes upper fresh-food compartments 14 having doors 16 and lower freezer compartment 18 having upper drawer 20 and lower drawer 22. Drawers 20, 22 are “pull-out” type drawers in that they can be manually moved into and out of freezer compartment 18 on suitable slide mechanisms. Refrigerator 10 is provided by way of example only. Other configurations for a refrigerator appliance may be used as well including appliances with only freezer compartments, only chilled compartments, or other combinations thereof different from that shown in FIG. 1. In addition, the heat pump and heat pump system of the present disclosure is not limited to refrigerator appliances and may be used in other applications as well such as e.g., air-conditioning, electronics cooling devices, and others. Thus, it should be understood that while the use of a heat pump and heat pump system to provide cooling within a refrigerator is provided by way of example herein, the present disclosure may also be used to provide for heating applications as well.

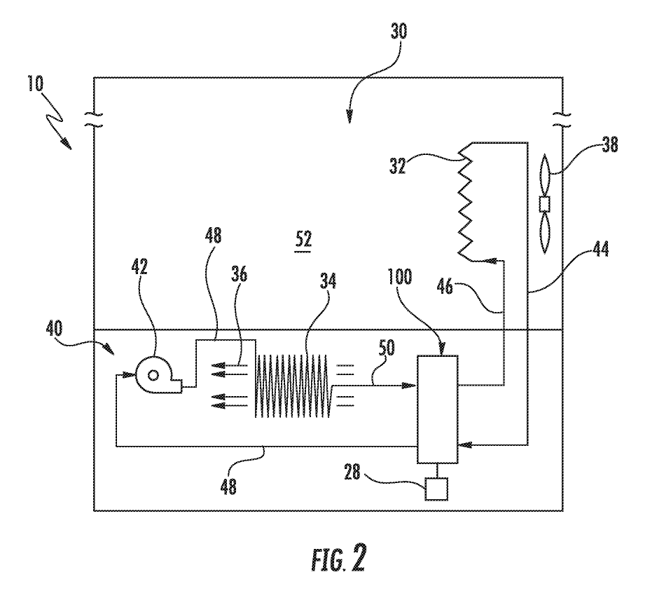

FIG. 2 is a schematic view of various components of refrigerator appliance 10, including a refrigeration compartment 30 and a machinery compartment 40. Refrigeration compartment 30 and machinery compartment 40 include a heat pump system 52 having a first or cold side heat exchanger 32 positioned in refrigeration compartment 30 for the removal of heat therefrom. A heat transfer fluid such as e.g., an aqueous solution, flowing within first heat exchanger 32 receives heat from refrigeration compartment 30 thereby cooling contents of refrigeration compartment 30. A fan 38 may be used to provide for a flow of air across first heat exchanger 32 to improve the rate of heat transfer from refrigeration compartment 30.

The heat transfer fluid flows out of first heat exchanger 32 by line 44 to heat pump 100. As will be further described herein, the heat transfer fluid receives additional heat from magneto-caloric material (MCM) in heat pump 100 and carries this heat by line 48 to pump 42 and then to second or hot side heat exchanger 34. Heat is released to the environment, machinery compartment 40, and/or other location external to refrigeration compartment 30 using second heat exchanger 34. A fan 36 may be used to create a flow of air across second heat exchanger 34 and thereby improve the rate of heat transfer to the environment. Pump 42 connected into line 48 causes the heat transfer fluid to recirculate in heat pump system 52. Motor 28 is in mechanical communication with heat pump 100, as will be further described.

From second heat exchanger 34, the heat transfer fluid returns by line 50 to heat pump 100 where, as will be further described below, the heat transfer fluid loses heat to the MCM in heat pump 100. The now colder heat transfer fluid flows by line 46 to first heat exchanger 32 to receive heat from refrigeration compartment 30 and repeat the cycle as just described.

Heat pump system 52 is provided by way of example only. Other configurations of heat pump system 52 may be used as well. For example, lines 44, 46, 48, and 50 provide fluid communication between the various components of heat pump system 52 but other heat transfer fluid recirculation loops with different lines and connections may also be employed. For example, pump 42 can also be positioned at other locations or on other lines in system 52. Still other configurations of heat pump system 52 may be used as well.

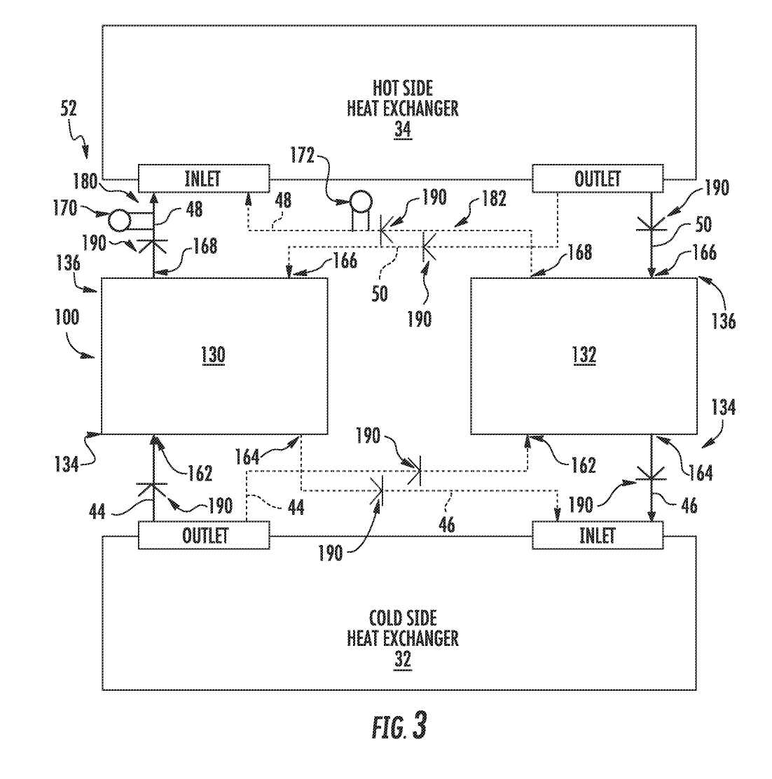

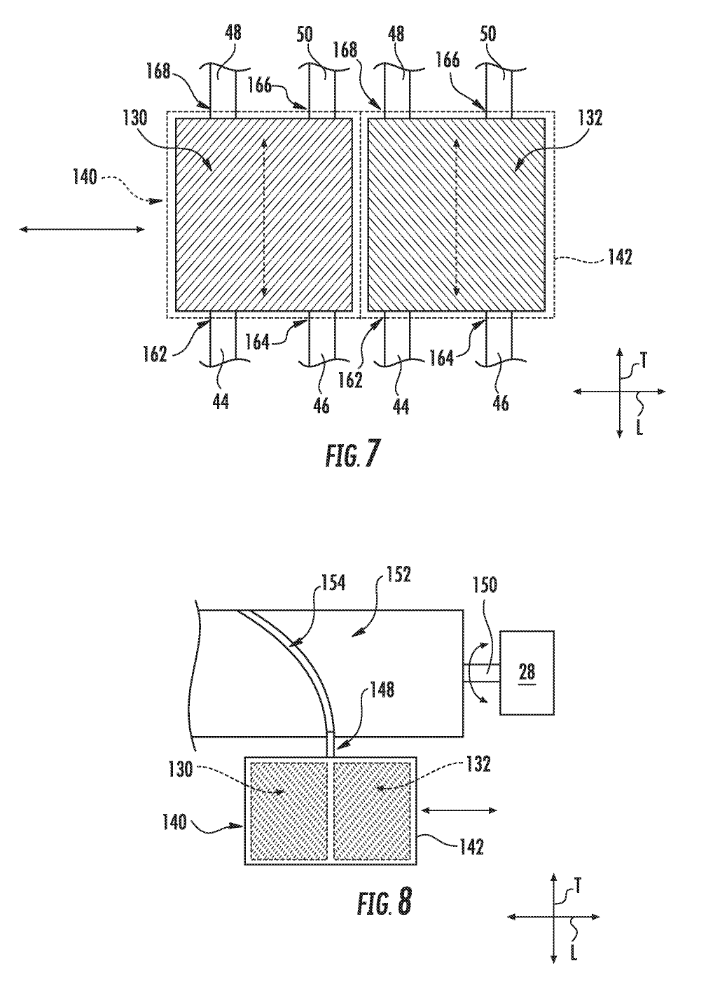

FIGS. 3 through 15 illustrate an exemplary heat pump 100 and components thereof, and the use of such heat pumps 100 with heat pump system 52, in accordance with exemplary embodiments of the present disclosure. Components of heat pump 100 may be oriented relative to a coordinate system for heat pump 100, which may include a vertical direction V, a transverse direction T and a lateral direction L, all of which may be mutually perpendicular and orthogonal to one another.

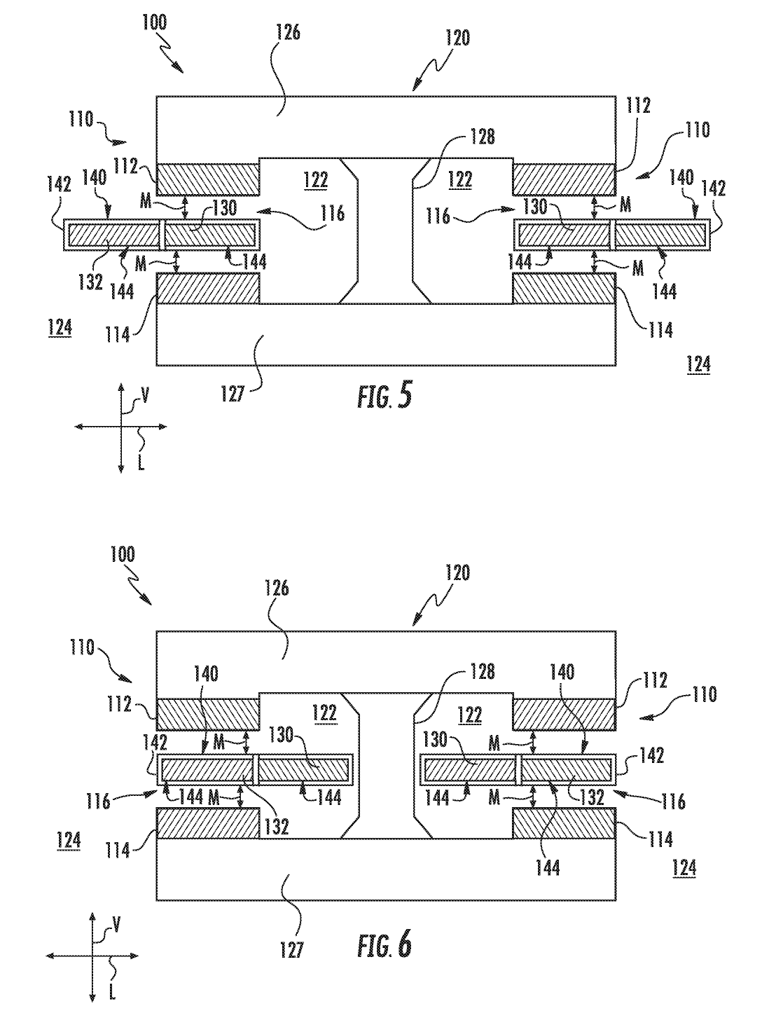

As shown in FIGS. 5 and 6, heat pump 100 includes one or more magnet assemblies 110, each of which creates a magnetic field M. For example, a magnetic field M may be generated by a single magnet, or by multiple magnets. In exemplary embodiments as illustrated, a first magnet 112 and a second magnet 114 may be provided, and the magnetic field M may be generated between magnets 112, 114. Magnets 112, 114 may, for example, have opposite magnetic polarities such that they either attract or repel each other. Magnets 112, 114 of magnet assembly 110 may also be spaced apart from each other, such as along the vertical direction V. A gap 116 may thus be defined between first magnet 112 and second magnet 114, such as along the vertical direction V.

Heat pump 100 may further include a support frame 120 which supports magnet assembl(ies) 110. Magnet assembly 110 may be connected to support frame 120. For example, each magnet 112, 114 of magnet assembly 110 may be connected to support frame 120. Such connection in exemplary embodiments is a fixed connection via a suitable adhesive, mechanical fasteners and/or a suitable connecting technique, such as welding, brazing, etc. Support assembly 120 may, for example, support magnets 112, 114 in position such that gap 114 is defined between magnets 112, 114.

As illustrated, support frame 120 is an open-style frame, such that interior portions of support frame 120 are accessible from exterior to support frame 120 (e.g. in the lateral and transverse directions L, T) and components of heat pump 100 can be moved from interior to support frame 120 to exterior to support frame 120 and vice-versa. For example, support frame 120 may define one or more interior spaces 122. Multiple interior spaces 122, as shown, may be partitioned from each other by frame members or other components of the support frame 120. An interior space 122 may be contiguous with associated magnets 112, 114 (i.e. magnet assembly 110) and gap 116, such as along the lateral direction L. Support frame 120 may additionally define one or more exterior spaces 124, each of which includes the exterior environment proximate support frame 120. Specifically, an exterior space 124 may be contiguous with associated magnets 112, 114 (i.e. magnet assembly 110) and gap 116, such as along the lateral direction L. An associated interior space 122 and exterior space 124 may be disposed on opposing sides of associated magnets 112, 114 (i.e. magnet assembly 110) and gap 116, such as along the lateral direction L. Thus, magnet assembly 110 and gap 116 may be positioned between an associated interior space 122 and exterior space 124, e.g., along the lateral direction L.

As illustrated in FIGS. 5 and 6, support frame 120, frame members and other components thereof may include and form one or more C-shaped portions. A C-shaped portion may, for example, define an interior space 122 and associated gap 116, and may further define an associated exterior space 124 as shown. In exemplary embodiments as illustrated, support frame 120 may support two magnet assemblies 110, and may define an interior space 122, gap 116, and exterior space 124 associated with each of two magnet assemblies 110. Alternatively, however, a support frame 120 may support only a single magnet assembly 110 or three or more magnet assemblies 110.

Various frame members may be utilized to form support frame 120. For example, in some exemplary embodiments, an upper frame member 126 and a lower frame member 127 may be provided. Lower frame member 127 may be spaced apart from upper frame member 126 along the vertical axis V. First magnet(s) 112 may be connected to upper frame member 126, and second magnet(s) 114 may be connected to lower frame member 127. In exemplary embodiments, upper frame member 126 and lower frame member 127 may be formed from materials which have relatively high magnetic permeability, such as iron.

In some exemplary embodiments, as illustrated in FIGS. 5 and 6, a support frame 120 may further include an intermediate frame member 128. Intermediate frame member 128 may be disposed and extend between and connect upper frame member 126 and lower frame member 127, and may in some exemplary embodiments be integrally formed with upper and lower frame members 126, 127. As shown, multiple interior spaces 122 may be partitioned from each other by intermediate frame member 128. In some exemplary embodiments, intermediate frame member 128 may be formed from materials which have relatively high magnetic permeability, such as iron. In other exemplary embodiments, intermediate frame member 128 may be formed from materials which have relatively lower magnetic permeability than those of upper and lower frame members 126, 127. Accordingly, such materials, termed magnetically shielding materials herein, may facilitate direction of magnetic flux paths only through upper and lower frame members 126, 127 and magnet assemblies 110, advantageously reducing losses in magnetic strength, etc.

Referring to FIGS. 3 through 11, heat pump 100 may further include a plurality of stages, each of which includes a magneto-caloric material (MCM). In exemplary embodiments, such MCM stages may be provided in pairs, each of which may for example include a first stage 130 and a second stage 132. Each stage 130, 132 may include one or more different types of MCM. Further, the MCM(s) provided in each stage 130, 132 may be the same or may be different.

As provided in heat pump 100, each stage 130, 132 may extend, such as along the transverse direction T, between a first end portion 134 and a second end portion 136. As discussed herein, working fluid (also referred to herein as heat transfer fluid or fluid refrigerant) may flow into each stage 130, 132 and from each stage 130, 132 through first end portion 134 and second end portion 136. Accordingly, working fluid flowing through a stage 130, 132 during operation of heat pump 100 flows generally along the transverse direction T between first and second end portions 134, 136 of stages 130, 132.

Stages 130, 132, such as each pair of stages 130, 132, may be disposed within regenerator housings 140. Regenerator housing 140 along with stages 130, 132 and optional insulative materials may collectively be referred to as a regenerator assembly. As shown in FIGS. 5 and 6, regenerator housing 140 includes a body 142 which defines a plurality of chambers 144, each of which extends along the transverse direction T between opposing ends of chamber 144. Chambers 144 of a regenerator housing 140 may thus be arranged in a linear array along the lateral direction L, as shown. Each stage 130, 132, such as of a pair of stages 130, 132, may be disposed within one of chambers 144 of a regenerator housing 140. Accordingly, these stages 130, 132 may be disposed in a linear array along the lateral direction L. As illustrated, in exemplary embodiments, each regenerator housing 140 may include a pair of stages 130, 132. Alternatively, three, four or more stages 130, 132 may be provided in a regenerator housing 140.

The regenerator housing(s) 140 (and associated stages 130, 132) and magnet assembly(s) 110 may be movable relative to each other, such as along the lateral direction L. In exemplary embodiments as shown, for example, each regenerator housing 140 (and associated stages 130, 132) is movable relative to an associated magnet assembly 110, such as along the lateral direction L. Alternatively, however, each magnet assembly 110 may be movable relative to the associated regenerator housing 140 (and associated stages 130, 132), such as along the lateral direction L.

Such relative movement between regenerator housing 140 and an associated magnet assembly 110 causes movement of each stage 130, 132 into the magnetic field M and out of the magnetic field M. As discussed herein, movement of a stage 130, 132 into the magnetic field M may cause the magnetic moments of the material to orient and the MCM to heat (or alternatively cool) as part of the magneto-caloric effect. When one of stages 130, 132 is out of the magnetic field M, the MCM may thus cool (or alternatively heat) due to disorder of the magnetic moments of the material.

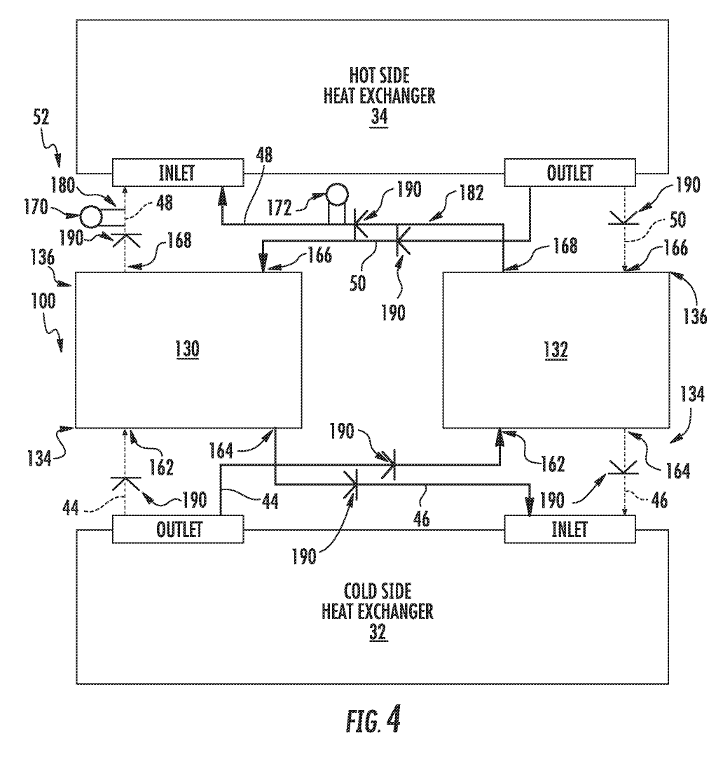

For example, a regenerator housing 140 (or an associated magnet assembly 110) may be movable along the lateral direction L between a first position and a second position. In the first position (as illustrated for example in FIGS. 3 and 5), regenerator housing 140 may be positioned such that first stage 130 disposed within regenerator housing 140 is within the magnetic field M and second stage 132 disposed within regenerator housing 140 is out of the magnetic field M. Notably, being out of the magnetic field M means that second stage 132 is generally or substantially uninfluenced by the magnets and resulting magnetic field M. Accordingly, the MCM of the stage as a whole may not be actively heating (or cooling) as it would if within the magnetic field M (and instead may be actively or passively cooling (or heating) due to such removal of the magnetic field M). In the second position (as illustrated for example in FIGS. 4 and 6), regenerator housing 140 may be positioned such that first stage 130 disposed within regenerator housing 140 is out of the magnetic field M and second stage 132 disposed within regenerator housing 140 is within the magnetic field M.

Regenerator housing 140 (or an associated magnet assembly 110) is movable along the lateral direction L between the first position and the second position. Such movement along the lateral direction L from the first position to the second position may be referred to herein as a first transition, while movement along the lateral direction L from the second position to the first position may be referred to herein as a second transition.

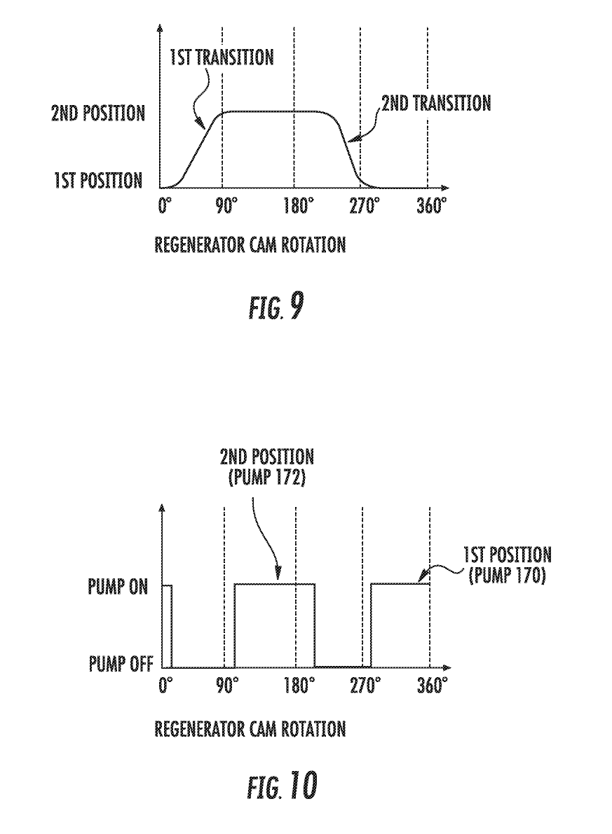

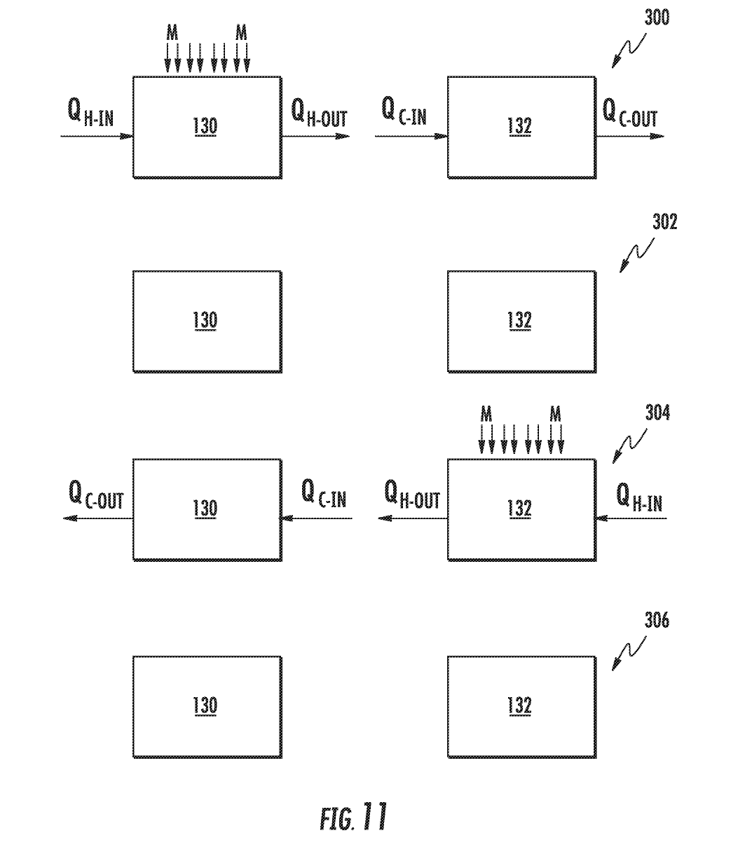

Referring to FIGS. 8 and 9, movement of a regenerator housing 140 (or an associated magnet assembly 110) may be caused by operation of motor 26. Motor 26 may be in mechanical communication with regenerator housing 140 (or magnet assembly 110) and configured for moving regenerator housing 140 (or magnet assembly 110) along the lateral direction L (i.e. between the first position and second position). For example, a shaft 150 of motor 28 may be connected to a cam. The cam may be connected to the regenerator housing 140 (or associated magnet assembly 110), such that relative movement of the regenerator housing 140 and associated magnet assembly 110 is caused by and due to rotation of the cam. The cam may, as shown, be rotational about the lateral direction L.

For example, in some exemplary embodiments as illustrated in FIGS. 8 and 9, the cam may be a cam cylinder 152. Cam cylinder 152 may be rotational about an axis that is parallel to the lateral direction L. A cam groove 154 may be defined in cam cylinder 152, and a follower tab 148 of regenerator housing 120 may extend into cam groove 154. Rotation of motor 28 may cause rotation of cam cylinder 152. Cam groove 154 may be defined in a particularly desired cam profile such that, when cam cylinder 152 rotates, tab 148 moves along the lateral direction L between the first position and second position due to the pattern of cam groove 154 and in the cam profile, in turn causing such movement of regenerator housing 120.

FIG. 9 illustrates one exemplary embodiment of a cam profile which includes a first position, first transition, second position, and second transition. Notably, in exemplary embodiments the period during which a regenerator housing 140 (or an associated magnet assembly 110) is dwelling in the first position and/or second position may be longer than the period during which the regenerator housing 140 (or an associated magnet assembly 110) is moving in the first transition and/or second transition. Accordingly, the cam profile defined by the cam defines the first position, the second position, the first transition, and the second transition. In exemplary embodiments, the cam profile causes the one of regenerator housing 140 or magnet assembly 110 to dwell in the first position and the second position for periods of time longer than time periods in the first transition and second transition.

Referring again to FIG. 2, in some exemplary embodiments, lines 44, 46, 48, 50 may facilitate the flow of working fluid between heat exchangers 32, 34 and heat pump 100. Referring now to FIGS. 3, 4 and 7, in exemplary embodiments, lines 44, 46, 48, 50 may facilitate the flow of working fluid between heat exchangers 32, 34 and stages 130, 132 of heat pump 100. Working fluid may flow to and from each stage 130, 132 through various apertures defined in each stage. The apertures generally define the locations of working fluid flow to or from each stage. In some exemplary embodiments as illustrated in FIGS. 3, 4 and 7, multiple apertures (e.g., two apertures) may be defined in first end 134 and second end 136 of each stage 130, 132. For example, each stage 130, 132 may define a cold side inlet 162, a cold side outlet 164, a hot side inlet 166 and a hot side outlet 168. Cold side inlet 162 and cold side outlet 164 may be defined in each stage 130, 132 at first end 134 of stage 130, 132, and hot side inlet 166 and hot side outlet 168 may be defined in each stage 130, 132 at second end 136 of stage 130, 132. The inlets and outlets may provide fluid communication for the working fluid to flow into and out of each stage 130, 132, and from or to heat exchangers 32, 34. For example, a line 44 may extend between cold side heat exchanger 32 and cold side inlet 162, such that working fluid from heat exchanger 32 flows through line 44 to cold side inlet 162. A line 46 may extend between cold side outlet 164 and cold side heat exchanger 32, such that working fluid from cold side outlet 164 flows through line 46 to heat exchanger 32. A line 50 may extend between hot side heat exchanger 34 and hot side inlet 166, such that working fluid from heat exchanger 34 flows through line 50 to hot side inlet 166. A line 48 may extend between hot side outlet 168 and hot side heat exchanger 34, such that working fluid from hot side outlet 168 flows through line 48 to heat exchanger 34.

When a regenerator housing 140 (and associated stages 130, 132) is in a first position, a first stage 130 may be within the magnetic field and a second stage 132 may be out of the magnetic field. Accordingly, working fluid in first stage 130 may be heated (or cooled) due to the magneto-caloric effect, while working fluid in second stage 132 may be cooled (or heated) due to the lack of magneto-caloric effect. Additionally, when a stage 130, 132 is in the first position or second position, working fluid may be actively flowed to heat exchangers 32, 34, such as through inlets and outlets of the various stages 130, 132. Working fluid may be generally constant or static within stages 130, 132 during the first and second transitions.

One or more pumps 170, 172 (each of which may be a pump 42 as discussed herein) may be operable to facilitate such active flow of working fluid when the stages are in the first position or second position. For example, a first pump 170 (which may be or include a piston) may operate to flow working fluid when the stages 130, 132 are in the first position (such that stage 130 is within the magnetic field M and stage 132 is out of the magnetic field M), while a second pump 172 (which may be or include a piston) may operate to flow working fluid when the stages 130, 132 are in the second position (such that stage 132 is within the magnetic field M and stage 130 is out of the magnetic field M). Operation of a pump 170, 172 may cause active flow of working fluid through the stages 130, 132, heat exchangers 32, 34, and system 52 generally. Each pump 170, 172 may be in fluid communication with the stages 130, 132 and heat exchangers 32, 34, such as on various lines between stages 130, 132 and heat exchangers 32, 34. In exemplary embodiments as shown, the pumps 170, 172 may be on “hot side” lines between the stages 130, 132 and heat exchanger 34 (i.e. on lines 48). Alternatively, the pumps 170, 172 may be on “cold side” lines between the stages 130, 132 and heat exchanger 32 (i.e. on lines 44). Referring briefly to FIG. 10, operation of the pumps 170, 172 relative to movement of a regenerator housing 140 and associated stages 130, 132 through a cam profile is illustrated. First pump 170 may operate when the stages are in the first position, and second pump 172 may operate when the stages are in the second position.

Working fluid may be flowable from a stage 130, 132 through hot side outlet 168 and to stage 130, 132 through cold side inlet 162 when the stage is within the magnetic field M. Working fluid may be flowable from a stage 130, 132 through cold side outlet 164 and to the stage through hot side inlet 166 during movement of stage 130, 132 when the stage is out of the magnetic field M. Accordingly, and referring now to FIGS. 3 and 4, a first flow path 180 and a second flow path 182 may be defined. Each flow path 180 may include flow through a first stage 130 and second stage 132, as well as flow through cold side heat exchanger 32 and hot side heat exchanger 34. The flow of working fluid may occur either along the first flow path 180 or the second flow path 182, depending on the positioning of the first and second stages 130, 132.

FIG. 3 illustrates a first flow path 180, which may be utilized in the first position. In the first position, first stage 130 is within the magnetic field M, and second stage 132 is out of the magnetic field M. Activation and operation of pump 170 may facilitate active working fluid flow through first flow path 180. As shown, working fluid may flow from cold side heat exchanger 32 through line 44 and cold side inlet 162 of first stage 130 to the first stage 130, from first stage 130 through hot side outlet 168 and line 48 of first stage 130 to hot side heat exchanger 34, from hot side heat exchanger 34 through line 50 and hot side inlet 166 of second stage 132 to second stage 132, and from second stage 132 through cold side outlet 164 and line 46 of second stage 132 to cold side heat exchanger 32.

FIG. 4 illustrates a second flow path 182, which may be utilized during the second position. In the second position, second stage 132 is within the magnetic field M, and first stage 130 is out of the magnetic field M. Activation and operation of pump 172 may facilitate active working fluid flow through second flow path 182. As shown, working fluid may flow from cold side heat exchanger 32 through line 44 and cold side inlet 162 of second stage 132 to second stage 132, from second stage 132 through hot side outlet 168 and line 48 of second stage 132 to hot side heat exchanger 34, from hot side heat exchanger 34 through line 50 and hot side inlet 166 of first stage 130 to first stage 130, and from first stage 130 through cold side outlet 164 and line 46 of first stage 130 to cold side heat exchanger 32.

Notably, check valves 190 may in some exemplary embodiments be provided on the various lines 44, 46, 48, 50 to prevent backflow there-through. Check valves 190, in combination with differential pressures during operation of heat pump 100, may thus generally prevent flow through the improper flow path when working fluid is being actively flowed through one of flow paths 190, 192.

For example, flexible lines 44, 46, 48, 50 may each be formed from one of a polyurethane, a rubber, or a polyvinyl chloride, or another suitable polymer or other material. In exemplary embodiments, lines 44, 46, 48, 50 may further be fiber impregnated, and thus include embedded fibers, or may be otherwise reinforced. For example, glass, carbon, polymer or other fibers may be utilized, or other polymers such as polyester may be utilized to reinforce lines 44, 46, 48, 50.

FIG. 11 illustrates an exemplary method of the present disclosure using a schematic representation of associated stages 130, 132 of MCM during dwelling in and movement between the various positions as discussed herein. With regard to first stage 130, during step 300, which corresponds to the first position, stage 130 is fully within magnetic field M, which causes the magnetic moments of the material to orient and the MCM to heat as part of the magneto caloric effect. Further, pump 170 is activated to actively flow working fluid in first flow path 180. As indicated by arrow Q_{H-OUT}, working fluid in stage 130, now heated by the MCM, can travel out of stage 130 and along line 48 to second heat exchanger 34. At the same time, and as indicated by arrow Q_{H-IN}, working fluid from first heat exchanger 32 flows into stage 130 from line 44. Because working fluid from first heat exchanger 32 is relatively cooler than the MCM in stage 130, the MCM will lose heat to the working fluid.

In step 302, stage 130 is moved from the first position to the second position in the first transition. During the time in the first transition, working fluid dwells in the MCM of stage 130. More specifically, the working fluid does not actively flow through stage 130.

In step 304, stage 130 is in the second position and thus out of magnetic field M. The absence or lessening of the magnetic field is such that the magnetic moments of the material become disordered and the MCM absorbs heat as part of the magnetocaloric effect. Further, pump 172 is activated to actively flow working fluid in the second flow path 182. As indicated by arrow Q_{C-OUT}, working fluid in stage 130, now cooled by the MCM, can travel out of stage 130 and along line 46 to first heat exchanger 32. At the same time, and as indicated by arrow Q_{C-IN}, working fluid from second heat exchanger 34 flows into stage 112 from line 50 when stage 130 is in the second transition. Because working fluid from second heat exchanger 34 is relatively warmer than the MCM in stage 130, the MCM will lose some of its heat to the working fluid. The working fluid now travels along line 46 to first heat exchanger 32 to receive heat and cool refrigeration compartment 30.

In step 306, stage 130 is moved from the second position to the first position in the second transition. During the time in the second transition, the working fluid dwells in the MCM of stage 130. More specifically, the working fluid does not actively flow through stage 130.

With regard to second stage 132, during step 300, which corresponds to the first position, second stage 132 is out of magnetic field M. The absence or lessening of the magnetic field is such that the magnetic moments of the material become disordered and the MCM absorbs heat as part of the magneto-caloric effect. Further, pump 170 is activated to actively flow working fluid in first flow path 180. As indicated by arrow Q_{C-OUT}, working fluid in stage 132, now cooled by the MCM, can travel out of stage 132 and along line 46 to first heat exchanger 32. At the same time, and as indicated by arrow Q_{C-IN}, working fluid from second heat exchanger 34 flows into stage 112 from line 50 when stage 132 is in the second transition. Because working fluid from second heat exchanger 34 is relatively warmer than the MCM in stage 132, the MCM will lose some of its heat to the working fluid. The working fluid now travels along line 46 to first heat exchanger 32 to receive heat and cool the refrigeration compartment 30.

In step 302, stage 132 is moved from the first position to the second position in the first transition. During the time in the first transition, the working fluid dwells in the MCM of stage 132. More specifically, the working fluid does not actively flow through stage 132.

In step 304, stage 132 is in the second position and thus fully within magnetic field M, which causes the magnetic moments of the material to orient and the MCM to heat as part of the magneto caloric effect. Further, pump 172 is activated to actively flow working fluid in the second flow path 182. As indicated by arrow Q_{H}. OUT, working fluid in stage 132, now heated by the MCM, can travel out of stage 132 and along line 48 to second heat exchanger 34. At the same time, and as indicated by arrow Q_{H-IN}, working fluid from first heat exchanger 32 flows into stage 132 from line 44. Because working fluid from first heat exchanger 32 is relatively cooler than the MCM in stage 132, the MCM will lose heat to the working fluid.

In step 306, stage 132 is moved from the second position to the first position in the second transition. During the time in the second transition, working fluid dwells in the MCM of stage 132. More specifically, the working fluid does not actively flow through stage 132.

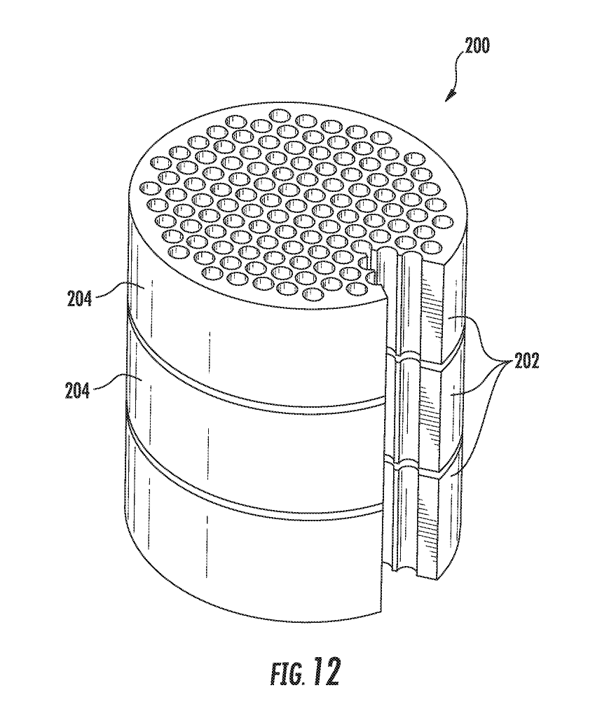

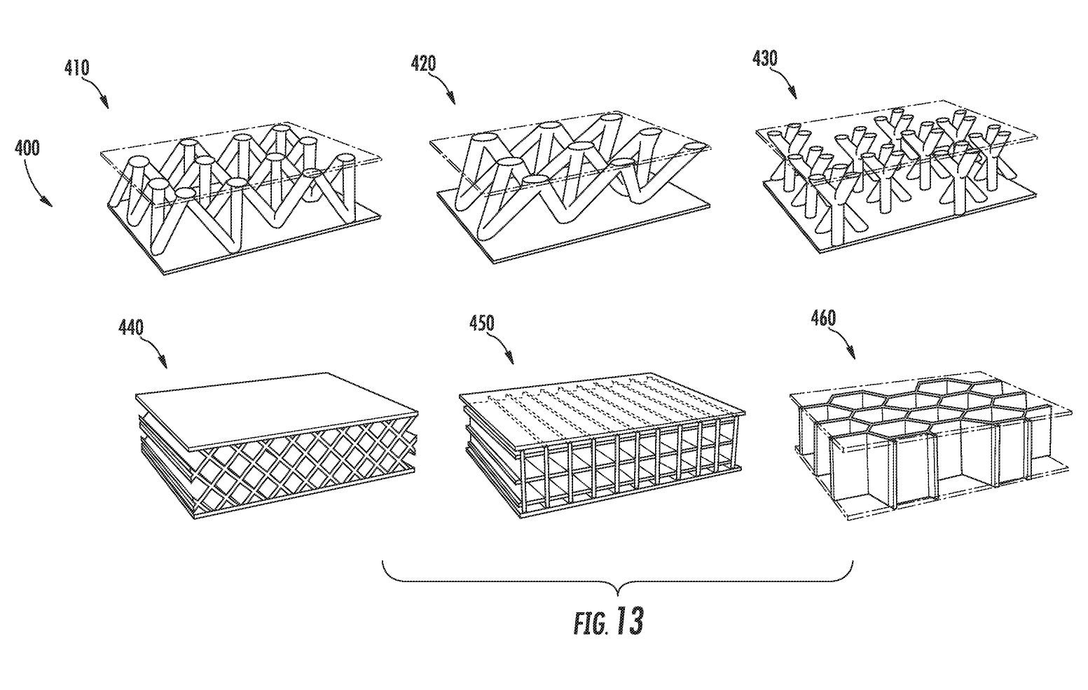

FIG. 12 provides a perspective view of a stack of caloric material stages 200 according to an exemplary embodiment of the present subject matter. Stack 200 may be used in or with any suitable caloric heat pump. For example, stack 200 may be used in or with heat pump 100 as one of stages 130, 132. Stack 200 may include features for facilitating heat transfer between caloric material of stack 200 and working fluid flowing through stack 200.

As may be seen in FIG. 12, stack 200 has a plurality of caloric material stages 202 that are stacked or distributed, e.g., linearly along an axial direction A of stack 200. Thus, each stage of stages 202 may be positioned adjacent and/or abut another stage of stages 202. In stack 200, each stage of stages 202 accepts and rejects heat to working fluid flowing through stack 200. Each stage of stages 202 may also include a different caloric material. The various, different caloric materials of stages 202 may assist with tuning an associated heat pump to operating conditions. In particular, the various, different caloric materials of stages 202 may accept and reject heat to working fluid flowing through stack 200 such that performance of the associated heat pump is tuned to operating conditions.

Stages 202 may include a first caloric material stage 204 and a second caloric material stage 206. First caloric material stage 204 may have or include a different caloric material than second caloric material stage 206. Thus, working fluid flowing through first caloric material stage 204 may undergo a different temperature change during operation of the associated heat pump than when the working fluid flows through second caloric material stage 206.

Each stage of stages 202 may be formed separately and then assembled together to form stack 200. Thus, first caloric material stage 204 and second caloric material stage 206 may be formed separately and then stacked together during formation of stack 200. By forming each stage of stages 202 separately and then assembling stages 202 into stack 200, heat conduction between stages 202 may be reduced relative to an integrally formed stack of stages, the cleaning and manufacturing of stages 202 is simplified, flexibility of constructing different stacks 200 is increased, and the possibility of repair is greatly enhanced. Stages 202 may also be formed such that a topology of stages 202 facilitates heat transfer between caloric material of stages 202 and working fluid flowing through stack 200. An exemplary method for forming stages 202 with suitable topologies is discussed in greater detail below in the context of FIG. 14.

FIG. 14 illustrates a method 300 for forming a caloric material stage according to an exemplary embodiment of the present subject matter. Method 300 may be used to form any suitable caloric material stage. For example, method 300 may be used to separately form each stage 202 of stack 200 (FIG. 12). Method 300 permits formation of various features in stages 202, as discussed in greater detail below. Method 300 may fabricate each stage of stages 202 as a unitary stage, e.g., such that the various layers of each stage of stages 202 are integrally formed together. More particularly, method 300 may include manufacturing or forming each stage of stages 202 using an additive process, such as Stereolithography (SLA), Digital Light Processing (DLP), Laser Net Shape Manufacturing (LNSM) and other known processes. An additive process fabricates components using three-dimensional information, for example a three-dimensional computer model, of the component. The three-dimensional information is converted into a plurality of slices, each slice defining a cross section of the component for a predetermined height of the slice. The component is then “built-up” slice by slice, or layer by layer, until finished.

As an example to facilitate understanding of the present subject matter, method 300 is described in greater detail below in the context of forming first stage 204. It will be understood that second stage 206 or any other stage of stages 202 may be formed in a similar manner using method 300. Accordingly, three-dimensional information of first stage 204 may first be determined. As an example, a model or prototype of first stage 204 may be scanned to determine the three-dimensional information of first stage 204. As another example, a model of first stage 204 may be constructed using a suitable CAD program to determine the three-dimensional information of first stage 204. The three-dimensional information is converted into a plurality of slices that each defines a cross-sectional layer of first stage 204. As an example, the three-dimensional information may be divided into equal sections or segments, e.g., along a central axis of first stage 204 or any other suitable axis. Thus, the three-dimensional information may be discretized, e.g., in order to provide planar cross-sectional layers of first stage 204. It will be understood that all or some of the steps of method 300 may be performed in an inert atmosphere, such as nitrogen, and/or in a vacuum (e.g., a substantial vacuum).

At 310 through 330, first stage 204 is fabricated using the additive process, or more specifically each layer is successively formed. At 310, a powder 312 is laid down. The powder 312 includes the caloric material of first stage 204. Next, at 320, a binder material 322 is applied to the powder 312. The binder material 322 connects or fixes a portion of the powder 312 in a topology of the first stage 204 corresponding to the particular layer of the first stage 204 being formed at 320. The binder material 322 may be polyethylene terephthalate (PET), an acrylic based binder, carbon metal, polyvinyl based binder, any low molecular weight polymer binder in which the polymer chain decouples upon heating, combinations thereof, etc. Excess powder may be removed, and, then at 330, another layer of powder 312 is applied over the remaining powder 312 and binder 322 from 320. The above described steps may be repeated for each layer of first stage 204. Thus, first stage 204 may be formed by repeatedly laying down powder 312 for each layer of first stage 204, applying binder material 322 onto powder 312 for each layer of first stage 204. The layers of first stage 204 may then be more permanently fixed to one another, e.g., with sintering, adhesive or any other suitable method or mechanism for fixing the layers of first stage 204 together. First stage 204 may also be treated (e.g., heat treated) to restore caloric effects of the caloric material, e.g., if the first stage 204 is sintered. In certain exemplary embodiments, layers of first stage 204 and layers of stage 206 may be additively formed separately, then stacked together, and sintered at the same time.

The layers may have any suitable size. For example, each layer may have a size between about five ten-thousandths of an inch and about one thousandths of an inch. First stage 204 may be fabricated using any suitable additive manufacturing machine. For example, any suitable inkjet printer or laserjet printer may be used during 310 through 330.

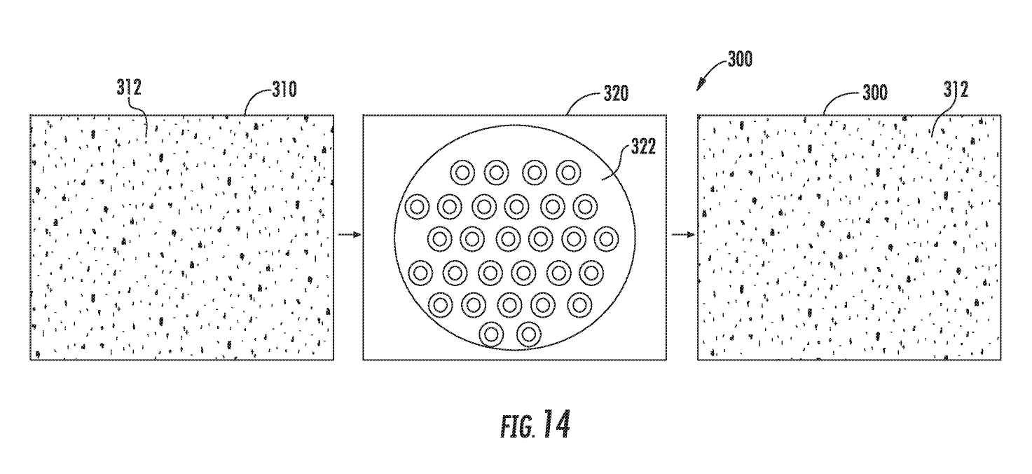

Using method 300, various topologies may be formed within first stage 204. FIG. 13 illustrates various caloric material stage topologies 400 as may be formed with method 300. As may be seen in FIG. 13, topologies 400 include a tetrahedral topology 410, a pyramidal topology 420, a 3D Kagomé topology 430, a diamond weave topology 440, a square weave topology 450, or a honeycomb topology 460. The caloric material of first stage 204 may be formed with method 300 to have any suitable one (or combination of) topologies 400. Thus, after forming first stage 204 with method 300, first stage 204 may have tetrahedral topology 410, pyramidal topology 420, 3D Kagomé topology 430, diamond weave topology 440, square weave topology 450, honeycomb topology 460, or any suitable combination thereof. Each stage of stages 202 may also be formed to have one (or a combination of) topologies 400 using method 300.

Topologies 400 may facilitate heat transfer between the caloric material of stages 202 and working fluid flowing through stack 200. In particular, topologies 400 may facilitate heat transfer between the caloric material of stages 202 and working fluid flowing through stack 200 while also limiting a pressure drop of the working fluid flowing through stack 200.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for forming a caloric regenerator, comprising:
forming a first caloric material stage from a first plurality of caloric material layers by repeatedly laying down a first powder for each layer of the first plurality of caloric material layers, applying a first binder material onto the first powder for each layer of the plurality of first caloric material layers, and then fixing the layers of the first plurality of caloric material layers to one another, the first binder material applied such that the first caloric material stage has a tetrahedral topology, a pyramidal topology, a 3D Kagomé topology, a diamond weave topology, a square weave topology, or a honeycomb topology; and
forming a second caloric material stage from a second plurality of caloric material layers by repeatedly laying down a second powder for each layer of the second plurality of caloric material layers, applying a second binder material onto the second powder for each layer of the plurality of second caloric material layers, and then fixing the layers of the second plurality of caloric material layers to one another, the second powder being different than the second powder;
wherein the first and second caloric material stages are stackable to form the caloric regenerator.

2. The method of claim 1, wherein the second binder material is applied such that the second caloric material stage has the tetrahedral topology, the pyramidal topology, the 3D Kagomé topology, the diamond weave topology, the square weave topology, or the honeycomb topology.

3. The method of claim 1, further comprising forming a third caloric material stage from a third plurality of caloric material layers by repeatedly laying down a third powder for each layer of the third plurality of caloric material layers, applying a third binder material onto the third powder for each layer of the plurality of third caloric material layers, and then fixing the layers of the third plurality of caloric material layers to one another, the third powder being different than the first and second powders,
wherein the first, second and third caloric material stages are stackable to form the caloric regenerator.

4. The method of claim 1, wherein the layers of the first plurality of caloric material layers are fixed to one another by sintering.

5. The method of claim 4, wherein the first caloric material stage is a first magneto-caloric material stage and forming the first caloric material stage also includes retuning a magnto-caloric effect of the first magneto-caloric material stage after sintering the first plurality of caloric material layers.

6. The method of claim 1, wherein the layers of the first plurality of caloric material layers are fixed to one another with an adhesive.

7. The method of claim 1, wherein the first and second binders are different.

8. The method of claim 1, wherein the first and second binders are a common binder.

9. The method of claim 1, wherein applying the first binder material onto the first powder comprises printing an adhesive.

10. The method of claim 1, wherein applying the first binder material comprises at least one of polyethylene terephthalate, an acrylic based binder, carbon metal or a polyvinyl based binder.

11. The method of claim 1, further comprising stacking the layers of the first plurality of caloric material layers with the layers of the second plurality of caloric material layers, wherein fixing the layers of the first plurality of caloric material layers to one another and fixing the layers of the second plurality of caloric material layers to one another comprises sintering the layers of the first plurality of caloric material layers and the layers of the second plurality of caloric material layers after stacking the layers of the first plurality of caloric material layers with the layers of the second plurality of caloric material layers.

12. The method of claim 1, wherein at least a portion the first caloric material stage and at least a portion of the second caloric material stage are formed in an inert atmosphere.

13. A method for forming a caloric regenerator, comprising:
step for forming a first caloric material stage from a first plurality of caloric material layers such that the first caloric material stage has a tetrahedral topology, a pyramidal topology, a 3D Kagomé topology, a diamond weave topology, a square weave topology, or a honeycomb topology; and
step for forming a second caloric material stage from a second plurality of caloric material layers such that the second caloric material stage has the tetrahedral topology, the pyramidal topology, the 3D Kagomé topology, the diamond weave topology, the square weave topology, or the honeycomb topology,
wherein the first and second caloric material stages are stackable to form the caloric regenerator.

14. The method of claim 13, wherein the step for forming the first caloric material stage comprises repeatedly laying down a first powder for each layer of the first plurality of caloric material layers, applying a first binder material onto the first powder for each layer of the plurality of first caloric material layers, and then fixing the layers of the first plurality of caloric material layers to one another.

15. The method of claim 14, wherein the layers of the first plurality of caloric material layers are fixed to one another by sintering.

16. The method of claim 15, wherein the first caloric material stage is a first magneto-caloric material stage and the step for forming the first caloric material stage further comprises retuning a magnto-caloric effect of the first magneto-caloric material stage after sintering the first plurality of caloric material layers.

17. The method of claim 14, wherein the layers of the first plurality of caloric material layers are fixed to one another with an adhesive.

18. The method of claim 14, wherein the step for forming the second caloric material stage comprises repeatedly laying down a second powder for each layer of the second plurality of caloric material layers, applying a second binder material onto the second powder for each layer of the plurality of second caloric material layers, and then fixing the layers of the second plurality of caloric material layers to one another, the second powder being different than the first powder.

19. The method of claim 18, further comprising forming a third caloric material stage from a third plurality of caloric material layers by repeatedly laying down a third powder for each layer of the third plurality of caloric material layers, applying a third binder material onto the third powder for each layer of the plurality of third caloric material layers, and then fixing the layers of the third plurality of caloric material layers to one another, the third powder being different than the first and second powders,
wherein the first, second and third caloric material stages are stackable to form the caloric regenerator.

20. The method of claim 18, wherein the first and second binders are different.

21. The method of claim 18, wherein the first and second binders are a common binder.

22. The method of claim 13, wherein at least a portion of the step for forming the first caloric material stage and at least a portion of the step for forming the second caloric material stage are performed in an inert atmosphere.
